(19) United States
(12) Patent Application Publication
(10) Pub. No.: US 2011/0102857 A1
(43) Pub. Date: May 5, 2011

(54) APPARATUS FOR STORING DATA TO HIGH PRIORITY REMOVABLE STORAGE DEVICE

(75) Inventor: MENG-WEN PAN, Hsinchu City (TW)

(73) Assignee: AVISION INC., Hsinchu (TW)

(21) Appl. No.: 12/916,138

(22) Filed: Oct. 29, 2010

(30) Foreign Application Priority Data
Oct. 30, 2009 (TW) 098136943

(51) Int. Cl. H04N 1/40

(52) U.S. Cl. 358/444

(57) ABSTRACT

An apparatus for storing data to a removable storage device includes a controlling unit, an image processing unit and a connecting interface. The image processing unit, electrically connected to the controlling unit, generates image data. The connecting interface is electrically connected to the controlling unit. The controlling unit sets the removable storage device as a default output destination of the image data in response to detection of the removable storage device connected to the connecting interface.

This application claims priority of No. 098136943 filed in Taiwan R.O.C. on Oct. 30, 2009 under 35 USC 119, the entire content of which is hereby incorporated by reference.

### BACKGROUND OF THE INVENTION

1. Field of the Invention

The invention relates in general to an apparatus for storing data to a high priority removable storage device, and more particularly to an image acquiring apparatus for storing data to a high priority removable storage device.

2. Related Art

In a conventional computer peripheral apparatus, the image data generated cannot be stored to a removable storage device unless the user has made complicated settings or selected the storage destination.

Thus, the user may be disinclined to use the apparatus. For example, one scanner may be shared among workers in the office. The office workers can use the scanner to scan documents and save the scanned data in a public computer connected to the scanner, and then send the scanned data to a recipient through the network or by E-mail. Sometimes, for privacy and security reasons, the users may not wish the scanned data to be accessed through this public computer by others and may choose to copy the scanned data stored in the public computer to a mobile disk. Such operation procedures for using the scanner are very complicated, and in some cases, the users might forget to delete the scanned data from the public computer. Although some scanning apparatuses may provide the selection to save the scanned data directly to the mobile disk, such function, however, has to be proceeded with an additional step of selecting or inputting the output destination of the scanned data through complex user interface screens, which causes to prolong the entire scan operation.

### SUMMARY OF THE INVENTION

It is therefore an object of the invention to provide an apparatus for storing data to a high priority removable storage device. With this apparatus, the user can save the image data, generated by this apparatus, to the removable storage device, without complicated setting processes, and the image data can be carried around and accessed through any other computer apparatus or computer peripheral apparatus as the users desire.

To achieve the above-identified object, the invention provides an apparatus for storing data to a removable storage device. The apparatus includes a controlling unit, an image processing unit and a connecting interface. The image processing unit, electrically connected to the controlling unit, generates image data. The connecting interface, electrically connected to the controlling unit, is capable of connecting to the removable storage device and outputting the image data to the removable storage device. The controlling unit sets the removable storage device as a default output destination of the image data in response to detection of the removable storage device connected to the connecting interface.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing an apparatus for storing data to a high priority removable storage device according to a preferred embodiment of the invention.

FIGS. 2 to 4 show several examples of the apparatus of the invention.

### DETAILED DESCRIPTION OF THE INVENTION

The present invention will be apparent from the following detailed description, which proceeds with reference to the accompanying drawings.

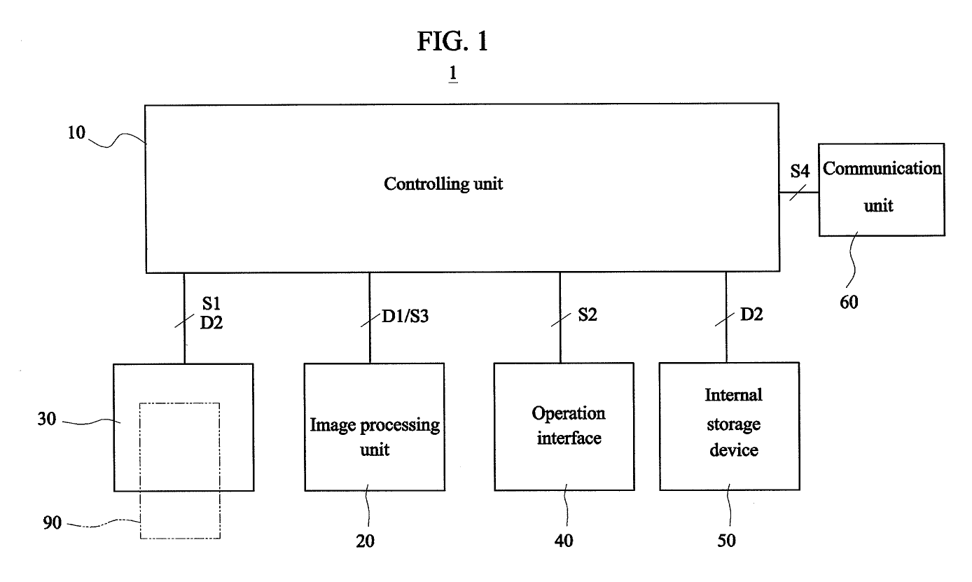

FIG. 1 is a schematic illustration showing an apparatus 1 for storing data to a high priority removable storage device 90 according to a preferred embodiment of the invention. Referring to FIG. 1, the apparatus 1 of this embodiment includes a controlling unit 10, an image processing unit 20 and a connecting interface 30.

The image processing unit 20, electrically connected to the controlling unit 10, generates image data D1 representing the image and processes the image data D1 into a digital file D2. For example, the image data D1 include an array of data elements. Each data element includes brightness values of multiple channels (e.g., red (R), green (G), blue (B) and white (W) channels). The image processing unit 20 may refer to, for example, a scanner, a digital camera, a camcorder, a web cam or a fax module. For the fax module, the image data D1 include encoded/modulated and compressed data.

The connecting interface 30, electrically connected to the controlling unit 10, may be a USB interface or a memory card reader.

The controlling unit 10 sets the removable storage device 90 as a default output destination of the image data D1 in response to detection of the removable storage device 90 connected to the connecting interface 30, upon which a connection signal S1 may be generated. When the removable storage device 90 is detected to be connected to this apparatus 1, the default output destination of this apparatus 1 is directed to this removable storage device 90. The removable storage device 90 may be a USB flash disk or a memory card, for example.

In addition, when the removable storage device 90 is connected to the connecting interface 30, the controlling unit 10 can activate the image processing unit 20 to generate the image data D1 according to the connection signal S1.

This apparatus 1 may further include an operation interface 40, electrically connected to the controlling unit 10, for receiving user input requesting the image processing unit 20 to generate the image data D1, where an operation signal S2 is transmitted to the image processing unit 20 upon receiving the user input. The user can press a start button on the operation interface 40 to activate the image processing unit 20 to generate the image data D1.

In addition, this apparatus 1 may further include an internal storage device 50 electrically connected to the controlling unit 10. When no removable storage device 90 is connected to this apparatus 1, the digital file D2 is stored to the internal storage device 50. Alternatively, the internal storage device 50 may serve as a buffer for the processing of the image data, so that the digital file D2 is temporarily stored to the internal storage device 50 and then stored to the removable storage device 90. The digital file D2 may also be stored to both of the internal storage device 50 and the removable storage device 90. When the removable storage device 90 is connected to the connecting interface 30, the controlling unit 10 sets the internal storage device 50 as the second output destination of the image data, in addition to setting the removable storage device 90 as the default output destination, such that the image data D1 is stored in both the removable storage device 90 and the internal storage device 50.

In order to solve the problem of the insufficient storage space of the removable storage device 90, the apparatus 1 may further include a communication unit 60. In this case, the controlling unit 10 detects the remaining storage space of the removable storage device 90, and outputs, when the remaining storage space is less than a predetermined threshold, a warning message S4 through a communication unit 60 to remind the user to insert another removable storage device 90, or provide the user with the selection to delete files in the removable storage device 90. The communication unit 60 may be a display or a speaker, for example.

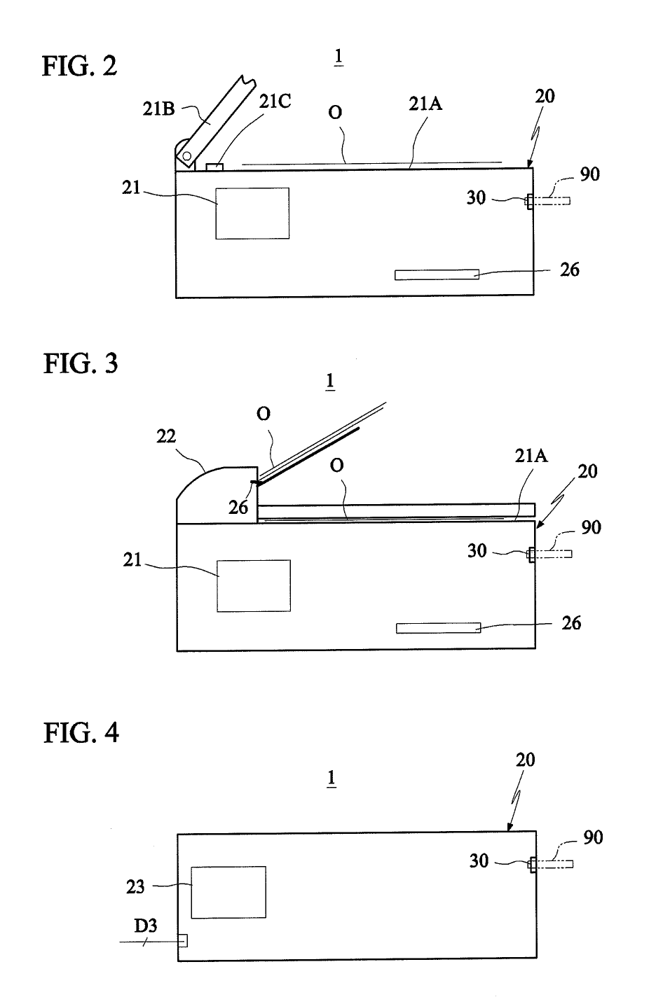

FIGS. 2 to 4 show several examples of the apparatus 1 of the invention. As shown in FIG. 2, the image processing unit 20 includes an image sensing unit 21 for sensing an image of an original O and generating the image data D1 representing the image. When the removable storage device 90 is connected to the connecting interface 30, the controlling unit 10 sets the removable storage device 90 as the output destination for the scanned images; that is, the user does not have to manually set the output destination for the scanned image, but the controlling unit 10 will automatically transfer the image data D1 obtained to the removable storage device 90. In addition, the image sensing unit 21 may be enabled when the removable storage device 90 is connected to this apparatus 1. The controlling unit 10 activates the image sensing unit 21 to sense the image of the original O and transfers the image data D1 to the removable storage device 90 after obtaining the image data D1, in response to the detection of the removable storage device 90 connected to the connecting interface 30. The apparatus 1 may further include a platen 21A, an upper cover 21B and an upper cover detector 21C. The upper cover 21B is rotatably connected to the platen 21A. The upper cover detector 21C detects if the upper cover 21B is in a closed position. The controlling unit 10 further activates the image sensing unit 21 to sense the image of the original O, in response to the detection of the upper cover 21B in the closed position. The upper cover detector 21C may be a mechanical detector or an optical detector.

The upper cover detector 21C generates a starting signal S3 when the upper cover 21B is in the closed position. In a first example, the controlling unit 10 sets the removable storage device 90 as the default output destination of the image data D1 when receiving the connection signal S1, and then when receiving the starting signal S3, the controlling unit 10 controls the image sensing unit 21 to sense the image of the original O. Thus, after the user connects the removable storage device 90 to the apparatus 1 and when the upper cover 21B is in the closed position, the scan operation will start. Alternatively, the scan operation can be started in a second manner. The controlling unit 10 receives the starting signal S3 when the upper cover 21B is detected in the closed position, but the controlling unit 10 will not activate the image sensing unit 21 to sense the image of the original O until it receives the connection signal S1 as well. After the controlling unit 10 receives the connection signal S1, the controlling unit 10 will set the removable storage device 90 as the default output destination of the image data D1 and activate the image sensing unit 21 to sense the image of the original O.

The removable storage device 90 may store personal scan parameters and settings. In this case, the controlling unit 10 retrieves the scan parameters, including resolutions and colors, from the removable storage device 90, and controls the image sensing unit 21 to operate according to the scan parameters.

The removable storage device 90 may store file formats, which may be a default format, TIF, PDF, JPG file formats and etc. The controlling unit 10 retrieves one of the file formats stored in the removable storage device 90, and controls the image processing unit 20 to convert the image data D1 into the file format. This file formats may be stored in the removable storage device as a file, named as, for example, “setup.txt”. In the setup.txt file, the scan parameters and the file formats are written in one single term. For example, they can be written in the form of (300, B, TIF), which represents that the original is scanned in the black-and-white mode with the resolution of 300 DPI and the image data of the original is stored as the TIF file. In another example, the term (300, C, JPG) represents the original is scanned in the color mode with the resolution of 300 DPI and the image data of the original is stored as the JPG file; and the term (200, C, PDF) represents the original is scanned in the color mode with the resolution of 200 DPI and the image data of the original is stored as the PDF file.

Such, the users can store their personal settings of scan parameters and file formats in a flash disk and obtain the desired image results by simply plugging the flash disk into the apparatus. This is a very convenient design, which may be similarly applied to the examples of FIGS. 3 and 4.

Referring to FIG. 3, the image processing unit 20 includes an image sensing unit 21 and the apparatus 1 further includes an automatic sheet feeder 22 for transporting the original O to and past the image sensing unit 21.

The apparatus 1 may further include a sheet detector 26, disposed in the automatic sheet feeder 22, for detecting the presence of the original O. Or another sheet detector 26 may be disposed under the platen 21A to detect presence of the original O on the platen 21A. The controlling unit 10 may activate the image sensing unit 21 to sense the image of the original O and transfers the image data D1 to the removable storage device 90 after obtaining the image data D1, in response to the detection of the presence of the original O. The sheet detector 26 generates a starting signal S3 when the presence of the original O is detected. The controlling unit 10 activates the image sensing unit 21 to sense the image of the original O when receiving the starting signal S3 transmitted by the sheet detector 26. Thus, the scan operation is started after the removable storage device 90 is connected to the apparatus 1 and the sheet detector 26 detects that the user has placed the original O on the automatic sheet feeder 22. Alternatively, the scan operation can be started in another way. The controlling unit 10 receives the starting signal S3 when the original O is placed on the automatic sheet feeder 22, but the controlling unit 10 will not activate the image sensing unit 21 to sense the image of the original O until it receives the connection signal S1 as well. After the controlling unit 10 receives the connection signal S1, the controlling unit 10 will set the removable storage device 90 as the default output destination of the image data D1 and activate the image sensing unit 21 to sense the image of the original O.

As shown in FIG. 4, the image processing unit 20 includes a fax module 23 for receiving fax data D3 and generating the image data D1 representing the fax data D3, and then converting the image data D1 into digital file D2. The subsequent processing procedures for the digital file D2 are similar to the processing procedures, which have been mentioned hereinabove and will be omitted here.

According to the embodiment of the invention, the user can store the image data D1, generated by this apparatus 1, to the removable storage device 90 without complicated settings, so that the image data D1 can be carried with the user and accessed through another computer apparatus or a computer peripheral apparatus. In addition, the user can connect the removable storage device 90 to this apparatus 1 to enable the function of scanning the document. The user can connect the removable storage device 90 to this apparatus 1 to enable the function of starting receiving the fax data. More particularly, in an apparatus with the combined functions of the fax module and the telephone, the user only needs to connect the removable storage device 90 to this apparatus 1 without pressing the manual receiving button when he or she ensures that the fax data are coming via the phone. Thus, this operation is timesaving and laborsaving.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An apparatus for storing data to a removable storage device, the apparatus comprising:
a controlling unit;
an image processing unit, electrically connected to the controlling unit, for generating image data; and
a connecting interface, electrically connected to the controlling unit, for connecting to the removable storage device and outputting the image data to the removable storage device, wherein the controlling unit sets the removable storage device as a default output destination of the image data in response to detection of the removable storage device connected to the connecting interface.

2. The apparatus according to claim 1, wherein the image processing unit comprises an image sensing unit for sensing an image of an original and generating the image data representing the image.

3. The apparatus according to claim 2, wherein the controlling unit further activates the image sensing unit to sense the image of the original in response to the detection of the removable storage device connected to the connecting interface.

4. The apparatus according to claim 2, further comprising:
a platen;
an upper cover rotatably connected to the platen; and
an upper cover detector, for detecting that the upper cover is in a closed position; wherein the controlling unit further activates the image sensing unit to sense the image of the original in response to the detection of the upper cover in the closed position.

5. The apparatus according to claim 2, further comprising an automatic sheet feeder, for transporting the original to and past the image sensing unit.

6. The apparatus according to claim 2, further comprising a sheet detector for detecting the presence of the original, wherein the controlling unit further activates the image sensing unit in response to the detection of the presence of the original.

7. The apparatus according to claim 2, wherein the controlling unit further retrieves a scan parameter stored in the removable storage device, and controls the image sensing unit to operate according to the scan parameter.

8. The apparatus according to claim 1, wherein the image processing unit further processes the image data into a digital file.

9. The apparatus according to claim 8, wherein the controlling unit further retrieves a file format stored in the removable storage device, and controls the image processing unit to convert the image data into the file format.

10. The apparatus according to claim 1, further comprising an operation interface, electrically connected to the controlling unit, for receiving user input requesting the image processing unit to generate the image data.

11. The apparatus according to claim 1, wherein the image processing unit comprises a fax module for receiving fax data and generating the image data representing the fax data.

12. The apparatus according to claim 1, further comprising an internal storage device electrically connected to the controlling unit.

13. The apparatus according to claim 12, wherein the controlling unit further sets the internal storage device as a second output destination of the image data in response to the detection of the removable storage device connected to the connecting interface, for the image data to be stored in both of the removable storage device and the internal storage device.

14. The apparatus according to claim 1, wherein the connecting interface comprises a universal serial bus (USB) interface.

15. The apparatus according to claim 1, wherein the connecting interface comprises a memory card reader.

16. The apparatus according to claim 1, further comprising a communication unit, wherein the controlling unit further detects a remaining storage space of the removable storage device and outputs a warning message through the communication unit when the remaining storage space is less than a predetermined threshold.
